(19) United States
(12) Patent Application Publication
(10) Pub. No.: US 2024/0308527 A1
(43) Pub. Date: Sep. 19, 2024

(54) ROAD SURFACE EVALUATION APPARATUS

(71) Applicants: Honda Motor Co., Ltd, Tokyo (JP); Pacific Consultants Co., Ltd., Tokyo (JP)

(72) Inventors: Atsuki Kakinuma, Tokyo (JP); Takeo Tokunaga, Tokyo (JP); Hiroyuki Onimaru, Tokyo (JP); Yasuo Oishi, Tokyo (JP); Akira Iihoshi, Tokyo (JP)

(21) Appl. No.: 18/602,019

(22) Filed: Mar. 12, 2024

(30) Foreign Application Priority Data
Mar. 16, 2023 (JP) 2023-041763

(51) Int. Cl. B60W 40/06; B60W 40/09; B60W 40/109

(52) U.S. Cl. CPC B60W 40/06; B60W 40/09; B60W 40/109; B60W 2552/00; B60W 2556/10

(57) ABSTRACT

A road surface evaluation apparatus includes a microprocessor is configured to perform: acquiring as driving information of a plurality of vehicles, position information of the plurality of vehicles, acceleration information indicating acceleration of the plurality of vehicles and map information of a predetermined road; calculating a degree of stability of a driving behavior of each of the plurality of vehicles based on the driving information when the plurality of vehicles drove on the predetermined road in a past; selecting a group of vehicles to be evaluated from among vehicles whose degree of stability is equal to or greater than a predetermined degree; evaluating a roughness of a road surface of the predetermined road based on the driving information of the group of vehicles; and outputting information on the roughness evaluated in the evaluating in association with the information of the predetermined road.

### CROSS-REFERENCE TO RELATED APPLICATION

This application is based upon and claims the benefit of priority from Japanese Patent Application No. 2023-041763 filed on Mar. 16, 2023, the content of which is incorporated herein by reference.

### BACKGROUND OF THE INVENTION

### Field of the Invention

The present invention relates to a road surface evaluation apparatus that evaluates a road surface profile representing unevenness of a road surface.

### Description of the Related Art

As an apparatus of this type, there has been conventionally known an apparatus configured to evaluate road surface roughness based on driving information including driving acceleration and the like acquired from a plurality of vehicles driving on the road (see, for example, WO 2022/059636 A).

However, in the method of acquiring driving information from a plurality of vehicles as in the apparatus described in WO 2022/059636, when the number of vehicles increases, the communication capacity between the apparatus and each vehicle increases, which may increase the load on the communication infrastructure.

### SUMMARY OF THE INVENTION

An aspect of the present invention is a road surface evaluation apparatus including a microprocessor and a memory connected to the microprocessor. The microprocessor is configured to perform: acquiring as driving information of a plurality of vehicles, position information of the plurality of vehicles, acceleration information indicating acceleration of the plurality of vehicles and map information including information of a predetermined road; calculating a degree of stability of a driving behavior of each of the plurality of vehicles based on the driving information when the plurality of vehicles drove on the predetermined road in a past; selecting a group of vehicles to be evaluated from among vehicles whose degree of stability is equal to or greater than a predetermined degree; evaluating a roughness of a road surface of the predetermined road based on the driving information of the group of vehicles; and outputting information on the roughness of the road surface evaluated in the evaluating in association with the information of the predetermined road.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of the configuration of a road surface evaluation system including a road surface evaluation apparatus according to the present embodiment;

FIG. 2 is a block diagram illustrating key components of an in-vehicle terminal;

FIG. 3 is a block diagram illustrating key components of the road surface evaluation apparatus according to the present embodiment;

FIG. 4A is a diagram illustrating an example of a map of a road on which vehicles are driving;

FIG. 4B is a diagram illustrating an example of driving information obtained by the road surface evaluation apparatus from in-vehicle terminals of vehicles driving on the road of FIG. 4A;

FIG. 5 is a diagram illustrating an example of composite driving information generated based on driving information acquired from the in-vehicle terminals of the vehicles driving on the road of FIG. 4A;

FIG. 6A is a diagram illustrating how to derive correlation between road surface roughness values and lateral acceleration;

FIG. 6B is a diagram illustrating how to derive the correlation between the road surface roughness values and the lateral acceleration;

FIG. 7 is a diagram illustrating an example of the road surface profile information;

FIG. 8 is a flowchart illustrating an example of processing executed by the processing unit in FIG. 3; and

FIG. 9 is a flowchart illustrating an example of processing executed by the processing unit in FIG. 3.

### DETAILED DESCRIPTION OF THE INVENTION

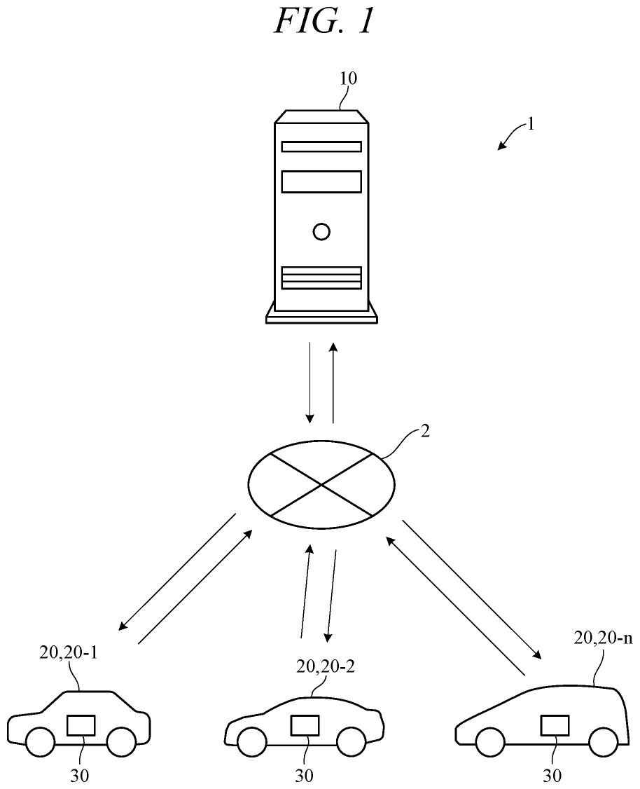

An embodiment of the present invention will be described below with reference to FIGS. 1 to 9. The road surface evaluation apparatus according to the present embodiment is an apparatus for evaluating the road surface profile of a road on which a vehicle is driving. FIG. 1 illustrates an example of the configuration of a road surface evaluation system including a road surface evaluation apparatus according to the present embodiment. As illustrated in FIG. 1, a road surface evaluation system 1 includes a road surface evaluation apparatus 10 and in-vehicle terminals 30. The road surface evaluation apparatus 10 includes, for example, a server device. The in-vehicle terminals 30 are configured to communicate with the road surface evaluation apparatus 10 via a communication network 2.

The communication network 2 includes not only public wireless communication networks represented by Internet networks and cell phone networks, but also closed communication networks established for each predetermined administrative region, such as wireless LAN, Wi-Fi (registered trademark), and Bluetooth (registered trademark).

The in-vehicle terminals 30 are installed in vehicles 20. The vehicles 20 include a plurality of vehicles 20-1, 20-2, . . . , and 20-n. Note that the vehicles 20 may be manually operated vehicles or automated vehicles. The vehicles 20 may include vehicles of different models and grades.

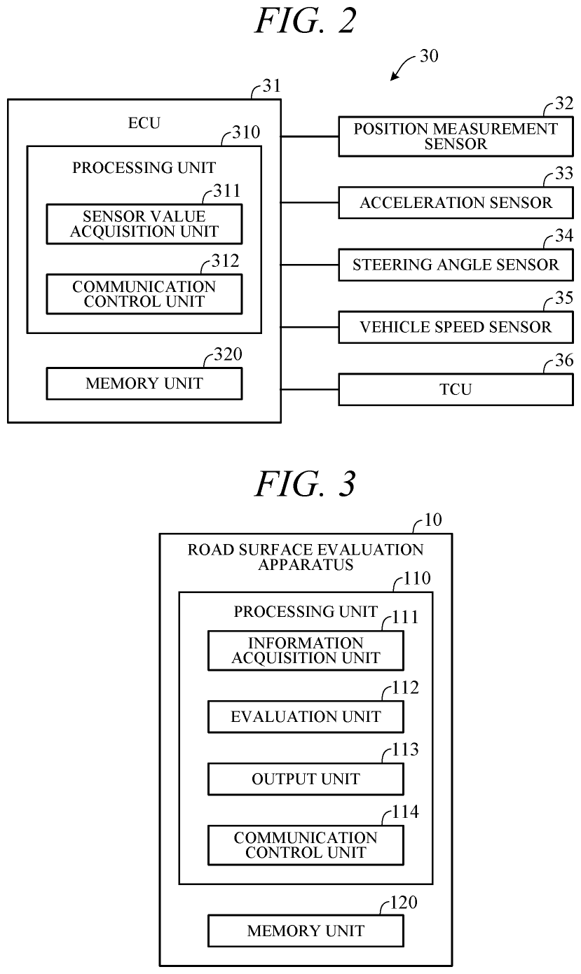

FIG. 2 is a block diagram illustrating the key components of the in-vehicle terminal 30 according to the present embodiment. The in-vehicle terminal 30 includes an electronic control unit (ECU) 31, a position measurement sensor 32, an acceleration sensor 33, a steering angle sensor 34, a vehicle speed sensor 35, and a telematic control unit (TCU) 36.

The position measurement sensor 32 is, for example, a GPS sensor, which receives positioning signals transmitted from GPS satellites and detects the absolute position (for example, latitude and longitude) of the vehicles 20. Note that the position measurement sensor 32 includes not only GPS sensors but also sensors that use radio waves transmitted from satellites in various countries, called GNSS satellites, including quasi-zenith orbit satellites.

The acceleration sensor 33 detects the acceleration of the vehicle 20 in the left-right direction, that is, lateral acceleration. Note that the acceleration sensor 33 may be configured to detect acceleration in the front-back direction and vertical direction as well as lateral acceleration of the vehicle 20. The steering angle sensor 34 detects the steering angle of the steering wheel (not shown) of the vehicle 20. The vehicle speed sensor 35 detects the vehicle speed of the vehicle 20.

As illustrated in FIG. 2, the ECU 31 includes a computer including a processing unit 310 such as a CPU (processor), a memory unit 320 such as ROM and RAM, and other peripheral circuits such as I/O interfaces not illustrated. The processing unit 310 functions as a sensor value acquisition unit 311 and a communication control unit 312 by executing programs stored in the memory unit 320 in advance.

The sensor value acquisition unit 311 acquires the detected values of the sensors 33 to 35 and the absolute position of the vehicle 20 detected by the position measurement sensor 32 at a predetermined cycle. The communication control unit 312 transmits the information acquired by the sensor value acquisition unit 311 (hereinafter referred to as driving information) to the road surface evaluation apparatus 10 at a predetermined cycle via the TCU 36, together with the vehicle ID that can identify the vehicle 20.

The road surface evaluation apparatus 10 detects the unevenness of the road surface, that is, the road surface roughness (hereinafter also referred to as a road surface profile), based on the values detected by the acceleration sensor 33 of the vehicle 20 (in-vehicle terminal 30). The detected road surface profile information is output to, for example, a terminal owned by a road management company or the like, and is used as reference data by the road management company when considering whether or not repairs are necessary. Specifically, the detected values of the acceleration sensor 33 are used to evaluate the road surface profile.

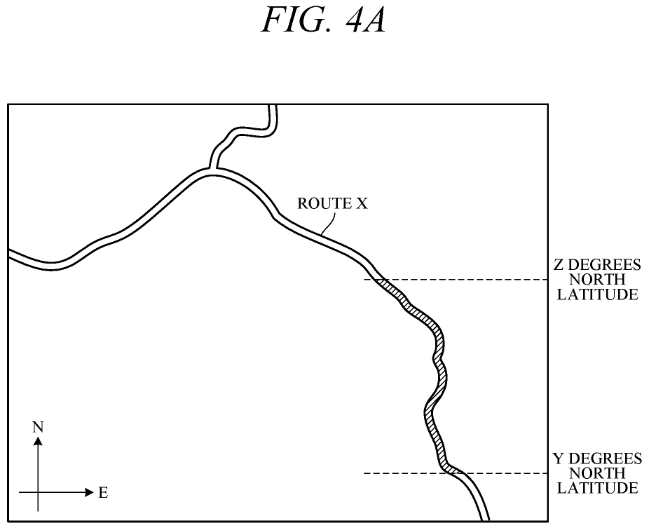

FIG. 3 is a block diagram illustrating the key components of the road surface evaluation apparatus 10 according to the present embodiment. The road surface evaluation apparatus 10 is configured to include a computer including a processing unit 110, such as a CPU, a memory unit 120 such as ROM and RAM, and other peripheral circuits such as I/O interfaces not illustrated. The memory unit 120 stores map information including road maps, and various kinds of information processed by the processing unit 110.

The processing unit 110 executes the programs stored in the memory unit 120, thereby functioning as an information acquisition unit 111, an evaluation unit 112, an output unit 113, and a communication control unit 114.

The information acquisition unit 111 receives driving information from the in-vehicle terminals 30 of the plurality of vehicles 20 driving on the road via the communication control unit 114. The driving information includes position information indicating the position of the vehicle 20 and acceleration information indicating the acceleration of the vehicle 20. The position information includes driving time information indicating the time when the vehicle 20 has driven the position. In addition, the driving information includes driving speed information indicating the driving speed of the vehicle 20. The driving speed information includes sensor values of the vehicle speed sensor 35, that is, the measured driving speed of the vehicle 20. Further, the driving information includes steering angle information indicating the steering angle of the steering wheel of the vehicle 20. The steering angle information includes the sensor value of the steering angle sensor 34, that is, the measured steering angle of the vehicle 20. The steering angle information may be configured to use information acquired by a yaw rate sensor (not shown) installed in the vehicle 20 (hereinafter referred to as yaw rate sensor information). Note that the information acquisition unit 111 can identify the vehicle 20 that is the transmission source of the driving information by the vehicle ID associated with the driving information.

The information acquisition unit 111 stores driving information received from the plurality of vehicles 20 (in-vehicle terminals 30) in the memory unit 120 in time series. Hereafter, the driving information stored in time series in the memory unit 120 is referred to as time-series driving information. The information acquisition unit 111 also acquires map information from the memory unit 120, including information on the road on which the vehicles 20 are driving.

The evaluation unit 112 evaluates the amount of unevenness (depth or height) of the road surface, or road surface roughness, based on the driving information of the plurality of vehicles 20 acquired by the information acquisition unit 111 within a predetermined period. More specifically, the evaluation unit 112 calculates the road surface roughness value indicating the degree of road surface roughness based on the lateral accelerations of the plurality of vehicles 20 acquired by the information acquisition unit 111 within a predetermined period. The road surface roughness values are, for example, values expressed in terms of the International Roughness Index (IRI), which is an international index. Hereinafter, the road surface roughness values may be simply referred to as roughness values.

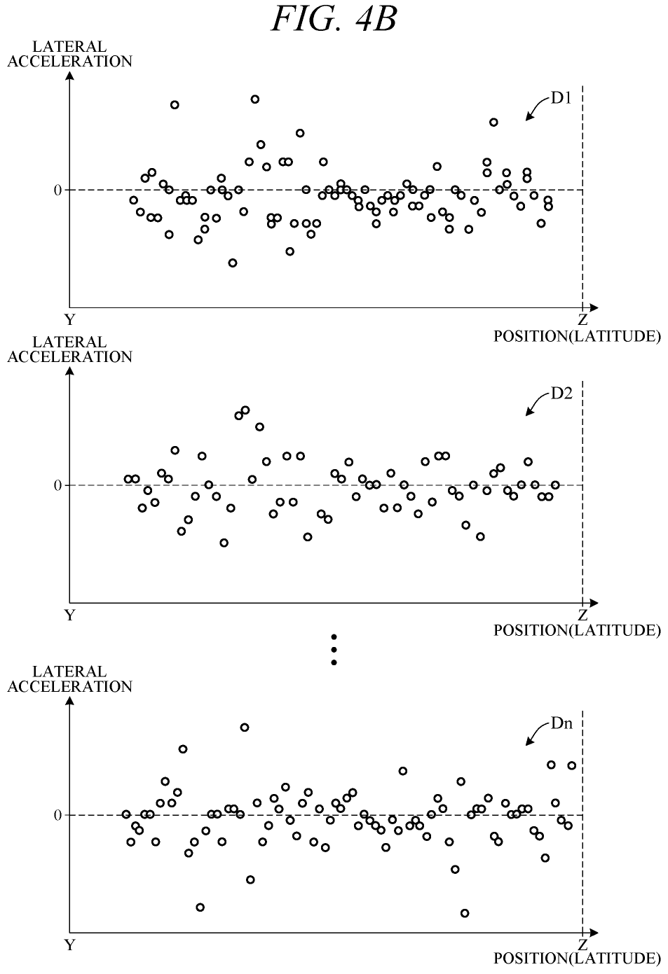

FIG. 4A is a diagram illustrating an example of a map of the road on which the vehicles 20 are driving. FIG. 4A illustrates the predetermined range of the road to be evaluated for the road surface roughness (latitude Y to Z on National Route X). In FIG. 4A, the upper direction corresponds to the north direction, and the right direction corresponds to the east direction. The predetermined road to be evaluated for road surface roughness (hereinafter referred to as the road to be evaluated) can be designated by a user such as a road management company. More specifically, information that can identify the road to be evaluated, such as the name and position of the road to be evaluated, is transmitted from a terminal owned by a road management company or the like to the road surface evaluation apparatus 10, whereby the road to be evaluated is designated. In a case where the road to be evaluated has a plurality of lanes on each side, the lane to be evaluated for road surface roughness may be designated by the user.

FIG. 4B illustrates an example of time-series driving information obtained by the road surface evaluation apparatus 10 from the in-vehicle terminals 30 of the vehicles 20 driving in the predetermined range (latitude Y to Z on National Route X) in FIG. 4A. The horizontal axis in the figure is the position (latitude) of the vehicles 20 in the driving direction along the traveling lane, and the vertical axis is the lateral acceleration of the vehicles 20. Characteristics D1, D2, . . . , Dn represent the time-series driving information of the vehicles 20-1, 20-2, . . . , 20-n, respectively.

Note that increasing the above sampling period improves the accuracy of the road surface roughness values calculated by the evaluation unit 112, allowing accurate evaluation of the road surface profile. However, a high sampling period (for example, 100 Hz) of driving information increases the processing load of the in-vehicle terminals 30. Furthermore, it increases the data volume of driving information transmitted to the road surface evaluation apparatus 10, which may put pressure on the bandwidth of the communication network 2. In consideration of this point, the evaluation unit 112 combines the driving information of a first cycle (for example, 1 Hz) transmitted from n vehicles 20 to generate the composite driving information of second cycle (1×n Hz), and calculates the road surface roughness values based on the composite driving information.

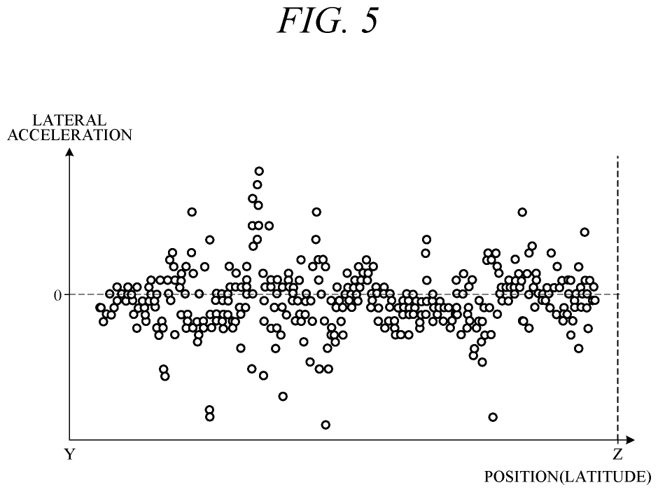

Here, generation of the composite driving information will be described with reference to FIG. 5.

FIG. 5 illustrates an example of composite driving information generated based on driving information acquired from the in-vehicle terminals 30 of the plurality of vehicles 20 driving on the road of FIG. 4A. The composite driving information is the information of the acceleration information of the vehicles 20 combined based on the position information of the vehicles 20. The composite driving information illustrated in FIG. 5 is acquired by superimposing the values of the vertical axis (lateral acceleration) for the vehicles 20 illustrated in FIG. 4B with reference to the horizontal axis (latitude). Since the vehicle speeds of the vehicles 20 and the points at which the vehicles 20 start sampling are different, the timing at which the driving information is sampled is considered to be different for each of the vehicles 20, even if the sampling cycle of the driving information for the vehicles 20 is the same. Therefore, by combining the 1 Hz driving information sampled in n vehicles 20 as described above, driving information equivalent to 1×n Hz is acquired. The evaluation unit 112 evaluates the surface roughness of the road on which the vehicles 20 are driving based on the composite driving information acquired in this manner.

In general, the greater the amount of unevenness of the road surface, the greater the lateral acceleration of the vehicles 20, and the road surface roughness values and lateral acceleration have a certain correlation. The evaluation unit 112 uses this correlation information (hereafter referred to as correlation data) to calculate the road surface roughness value corresponding to the vehicle position on the road from the lateral acceleration.

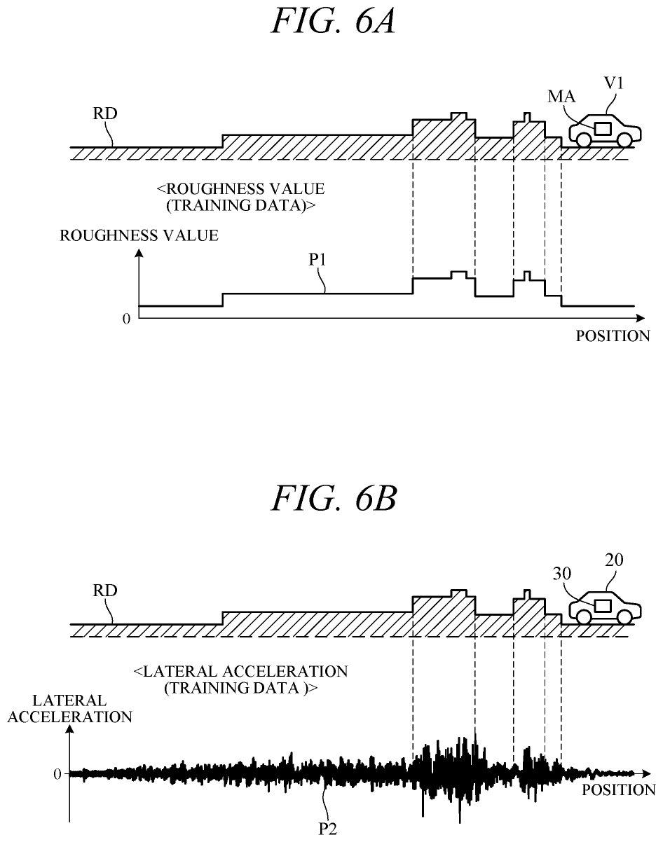

First, the evaluation unit 112 executes machine learning using pre-measured road surface roughness values and lateral acceleration as training data to derive the correlation between road surface roughness values and lateral acceleration. FIGS. 6A and 6B illustrate the training data for road surface roughness values and lateral acceleration, respectively. A vehicle V1 illustrated in FIG. 6A is a dedicated vehicle including a measuring instrument MA that measures road surface roughness. The measuring instrument MA measures the road surface roughness values of the road RD when the vehicle V1 is driving on a predetermined road (such as a course for measurement) RD. A characteristic P1 of FIG. 6A represents the road surface roughness values measured at this time, that is, the road surface roughness values used as the training data.

FIG. 6B illustrates the vehicles 20 in FIG. 1 driving on the same road RD as that in FIG. 6A. A characteristic P2 in FIG. 6B represents the lateral acceleration detected by the acceleration sensors 33 installed in the vehicles 20 while the vehicles 20 are driving on a predetermined road RD, that is, the lateral acceleration used as the training data.

The training data for road surface roughness values and lateral acceleration may be stored in the memory unit 120 of the road surface evaluation apparatus 10 or in an external storage device. The evaluation unit 112 performs machine learning using the training data for road surface roughness values and lateral acceleration read from the memory unit 120 or an external storage device to derive the correlation between the road surface roughness values and lateral acceleration. The driving speed, front/rear acceleration, and steering angle may be added as training data for machine learning.

The evaluation unit 112 calculates road surface roughness values for the road to be evaluated based on the correlation between the calculated road surface roughness values and lateral acceleration and the composite driving information corresponding to the road to be evaluated.

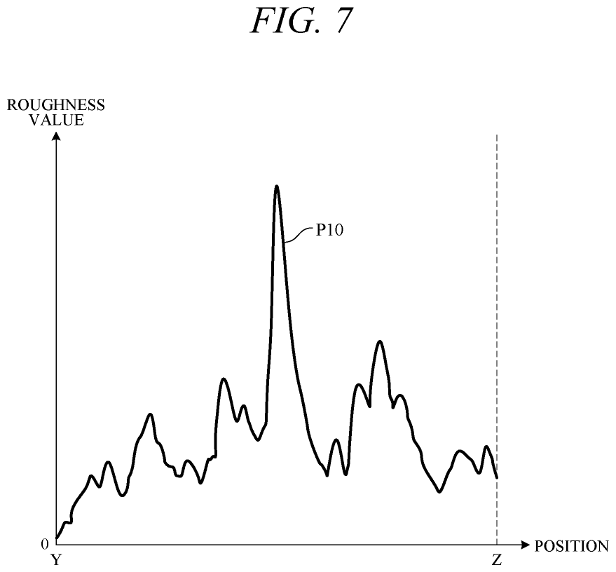

The output unit 113 outputs the road surface roughness information evaluated by the evaluation unit 112, that is, the road surface roughness values, in association with the road information acquired by the information acquisition unit 111. The information output at this time is referred to as road surface profile information. FIG. 7 illustrates an example of the road surface profile information. A characteristic P10 in the figure represents the road surface roughness value calculated based on the composite driving information illustrated in FIG. 5. The horizontal axis indicates the position (latitude) of the vehicles 20 in the driving direction along the traveling lane, and the vertical axis indicates the road surface roughness values. When the output unit 113 receives an output instruction for the road surface profile from a terminal such as a road management company via the communication network 2, it outputs the road surface profile information to the terminal from which the output instruction was transmitted or to a predetermined output destination terminal. The output instruction for the road surface profile may be input to the road surface evaluation apparatus 10 via an operation unit (not illustrated) included in the road surface evaluation apparatus 10. The road surface profile information is information that can be displayed on a display device such as a display, and the user (for example, a road management company) can check the road surface profile by displaying the road surface profile information on the display included in the user's terminal. When the road to be evaluated includes a section having a plurality of lanes on each side, the road surface profile information corresponding to the section may include the road surface roughness value for each lane. In this case, the road surface profile information may be information that displays the road surface roughness value for each lane in different modes (for example, different colors).

By the way, when the road surface roughness value is calculated based on the driving information of the plurality of vehicles 20 as described above, as the number of vehicles 20 increases, the data amount of the driving information transmitted to the road surface evaluation apparatus 10 increases, which may put pressure on the band of the communication network 2. On the other hand, the plurality of vehicles 20 may include vehicles that frequently repeat lane changes, sudden acceleration/deceleration, sudden steering, and the like during driving. If the road surface roughness value is calculated including the driving information of the vehicles 20 whose behavior during driving (hereinafter referred to as driving behavior) is unstable as described above, the road surface roughness may not be accurately evaluated. Therefore, in order to address such a problem, the evaluation unit 112 evaluates the road surface roughness as follows.

First, the evaluation unit 112 reads, from the memory unit 120, driving information acquired by the information acquisition unit 111 when the vehicle 20 has driven on the road to be evaluated in the past, and calculates the degree of stability of the driving behavior (hereinafter simply referred to as the degree of stability) of the vehicle 20 based on the driving information.

When the evaluation unit 112 calculates the degree of stability, it calculates, based on the driving speed information included in the driving information of the vehicle 20, a higher degree of stability for the vehicle 20 that has a smaller change in the driving speed. The evaluation unit 112 may calculate the driving speed of the vehicle 20 based on the temporal transition of the position information of the vehicle 20, more specifically, the temporal transition of the driving position of the vehicle 20 indicated by the position information of the vehicle 20 and use the driving speed for calculation of the degree of stability.

In addition, the evaluation unit 112 determines whether or not the vehicle has changed lanes based on the steering angle information included in the driving information of the vehicle 20, and calculates a higher degree of stability for the vehicle that changes lanes less frequently. The evaluation unit 112 may calculate the steering angle of the vehicle 20 based on the temporal transition of the position information of the vehicle 20 and use the steering angle for calculation of the degree of stability.

Further, the evaluation unit 112 calculates a higher degree of stability for the vehicle 20 having a low number of sudden operations based on the acceleration information of the vehicle 20. More specifically, the evaluation unit 112 generates sudden operation information indicating the presence or absence of sudden operation of the vehicle 20 based on the acceleration information included in the driving information of the vehicle 20. The sudden operation includes any one of sudden acceleration, sudden deceleration, and sudden steering.

The evaluation unit 112 selects a group of vehicles to be evaluated from the vehicles 20 whose degree of stability calculated by the evaluation unit 112 is equal to or greater than a predetermined degree. When an instruction to output the road surface profile is received by the output unit 113, the evaluation unit 112 reads the driving information of the group of vehicles to be evaluated from the driving information stored in the memory unit 120. The evaluation unit 112 evaluates the road surface roughness of the road to be evaluated based on the driving information of the group of vehicles. More specifically, the evaluation unit 112 calculates the road surface roughness value based on the lateral acceleration of the group of vehicles.

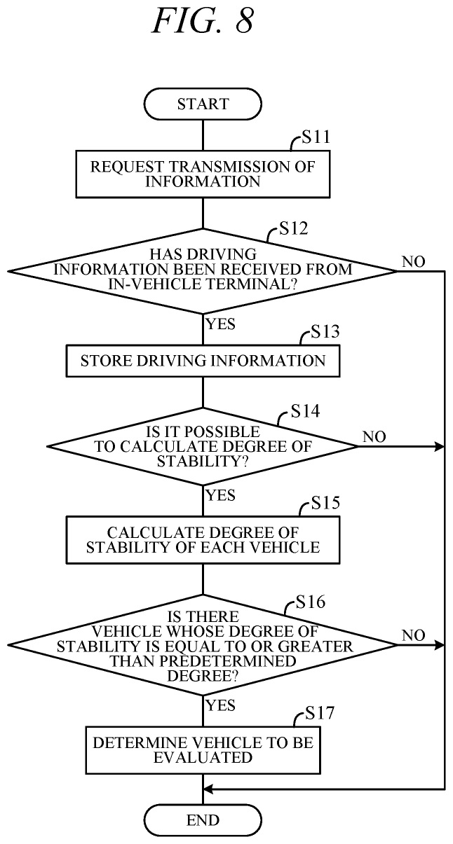

FIG. 8 is a flowchart illustrating an example of processing executed by the processing unit 110 (CPU) of the road surface evaluation apparatus 10 according to a predetermined program. The processing illustrated in this flowchart is repeated at a predetermined cycle when the road to be evaluated is designated by the user. First, in step S11, a command to request the transmission of driving information is transmitted to the driving vehicle 20 via the communication control unit 114. When the driving information is periodically or intermittently transmitted from the in-vehicle terminal 30 of the vehicle 20, the processing of step S11 may be skipped.

In step S12, it is determined whether driving information, which was transmitted from the in-vehicle terminal 30 of the vehicle 20 in response to the command in step S11, has been received. If NO in step S12, the processing ends. If YES in step S12, in step S13, the driving information received in step S12 is stored in the memory unit 120 together with the vehicle ID associated with the driving information. In step S14, it is determined whether or not sufficient driving information for calculating the degree of stability is accumulated in the memory unit 120. Specifically, it is determined whether the predetermined number or more of the vehicles 20 have driven on the road to be evaluated based on the position information included in the driving information and the vehicle IDs associated with the driving information. If NO in step S14, the processing ends. If YES in step S14, in step S15, the degree of stability of the driving behavior of each vehicle is calculated based on the driving information of each vehicle 20. In step S16, it is determined whether there is a vehicle whose degree of stability is equal to or greater than a predetermined degree. If YES in step S16, in step S17, the vehicle 20 whose degree of stability is equal to or greater than the predetermined degree is determined as the vehicle to be evaluated. At this time, when there is a plurality of vehicles 20 having a degree of stability equal to or greater than the predetermined degree, each vehicle 20 is determined as the vehicle to be evaluated.

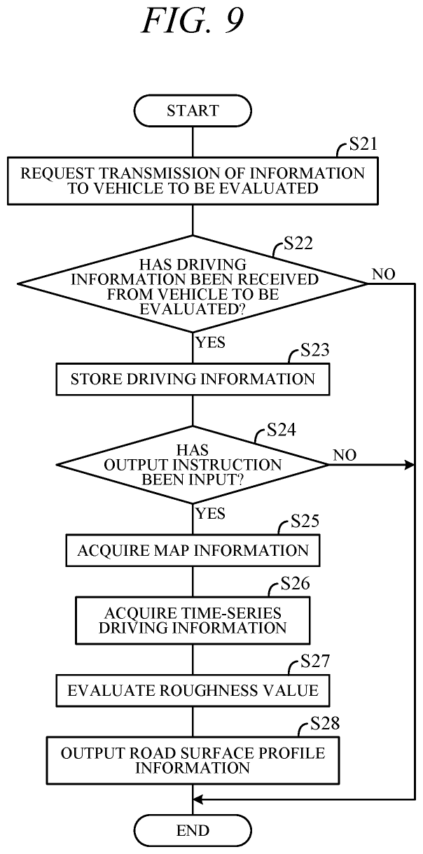

FIG. 9 is a flowchart illustrating an example of processing executed by the processing unit 110 (CPU) of the road surface evaluation apparatus 10 according to a predetermined program. The processing illustrated in this flowchart is repeated at a predetermined cycle when the vehicle to be evaluated is designated in step S17 in FIG. 8.

First, in step S21, a command to request the vehicle 20 to be evaluated to transmit the driving information is transmitted via the communication control unit 114. In step S22, it is determined whether driving information, which was transmitted from the in-vehicle terminal 30 of the vehicle 20 to be evaluated in response to the command in step S21, has been received. If NO in step S22, the processing ends. If YES in step S22, in step S23, the driving information received in step S22 is stored in the memory unit 120 together with the vehicle ID associated with the driving information. When the driving information is periodically or intermittently transmitted from the in-vehicle terminal 30 of the vehicle 20, the processing of step S21 may be skipped. In this case, it is determined whether or not the transmission source of the driving information is the vehicle to be evaluated based on the vehicle ID associated with the driving information received in step S22. When the transmission source is the vehicle to be evaluated, the driving information is stored in the memory unit 120 together with the vehicle ID.

In step S24, it is determined whether or not an instruction to output the road surface profile has been input (received). If NO in step S24, the processing ends. If YES in step S24, in step S25 map information is read from the memory unit 120 and road information included in the map information is acquired. In step S26, driving information of the vehicle 20 to be evaluated is acquired from the memory unit 120. More specifically, among the driving information of the vehicle 20 to be evaluated, driving information in which the position of the vehicle 20 indicated by the position information included in the driving information is on the road to be evaluated, that is, driving information corresponding to the road to be evaluated is read from the memory unit 120.

In step S27, composite driving information is generated based on the driving information read from the memory unit 120 in step S26, and the road surface roughness is evaluated based on the composite driving information. Next, in step S28, the road surface roughness information (roughness value) evaluated in step S27 is associated with the road information acquired in step S25, that is, road surface profile information is generated and output.

According to the embodiment of the present invention, the following effects can be achieved.

(1) The road surface evaluation apparatus 10 includes: an information acquisition unit 111 configured to acquire, as driving information of a plurality of vehicles 20, position information of the vehicles 20, acceleration information indicating the acceleration of the vehicles 20, and map information including road information; an evaluation unit 112 configured to calculate the degree of stability of the driving behavior of each of the vehicles 20 based on the driving information obtained by the information acquisition unit 111 when the vehicles 20 drove on the predetermined road in the past, selects a group of vehicles to be evaluated from among the vehicles 20 whose degree of stability is equal to or greater than the predetermined degree, and evaluate the roughness of the road surface of the predetermined road based on the driving information of the group of vehicles obtained by the information acquisition unit 111; and an output unit 113 configured to output the road surface roughness information evaluated by the evaluation unit 112 in association with the road information acquired by the information acquisition unit 111. This eliminates the need to acquire driving information from vehicles 20 other than those to be evaluated, even when the number of vehicles 20 increases, which allows efficient evaluation of road surface roughness. This also reduces the processing load on the apparatus and the load on the communication infrastructure between the apparatus and the vehicles.

(2) The information acquisition unit 111 acquires, as driving information, measured values of driving speeds of the plurality of vehicles 20 (sensor values of the vehicle speed sensor 35) transmitted from the plurality of vehicles 20. The evaluation unit 112 calculates, based on the driving speed of the plurality of vehicles 20 calculated from the temporal transition of the position information of the vehicles 20 or the measured driving speed of the vehicles 20, a higher degree of stability for the vehicle having a smaller change in the driving speed. This allows calculation of the road surface roughness value based on the driving information of the vehicles 20 having less fluctuation in the driving speed, thereby allowing more accurate evaluation of road surface roughness.

(3) The information acquisition unit 111 acquires, as driving information, measured steering angles of a plurality of vehicles 20 (sensor values of the steering angle sensor 34) transmitted from the plurality of vehicles 20. The information acquisition unit 111 acquires, as driving information, lane change information indicating whether or not each of the plurality of vehicles 20 has performed a lane change based on the temporal transition of the position information of each of the plurality of vehicles 20 or the sensor value of the steering angle sensor of each of the plurality of vehicles 20. The evaluation unit 112 calculates a higher degree of stability for the vehicle 20 with fewer number of lane changes based on the lane change information. This allows calculation of the road surface roughness value based on the driving information of the vehicle 20 continuously driving in the same lane, thereby allowing accurate evaluation of the road surface roughness of the road even when the road has a plurality of lanes on each side and the road surface conditions vary from lane to lane.

(4) The evaluation unit 112 further generates sudden operation information indicating the presence or absence of a sudden operation of each of the plurality of vehicles 20 based on the acceleration information of each of the plurality of vehicles 20 included in the driving information acquired by the information acquisition unit 111. The evaluation unit 112 calculates a higher degree of stability for the vehicle 20 having a lesser number of sudden operations based on the generated sudden operation information. The sudden operation includes any one of sudden acceleration, sudden deceleration, and sudden steering. This allows calculation of the road surface roughness value based on the driving information transmitted from the vehicle 20 having a low number of sudden operations, thereby allowing more accurate evaluation of the road surface roughness.

The above embodiment can be modified into various forms. Modifications are described below.

When the driving speed of the vehicle 20 becomes equal to or lower than a certain speed, such as when the road on which the vehicle 20 is driving is congested, the lateral acceleration caused by the unevenness of the road surface may no longer show the correlation as described above. Therefore, even if a road surface roughness value is calculated from the lateral acceleration of the vehicle 20, accurate road surface roughness value may not be obtained. Therefore, the evaluation unit 112 may calculate a driving total time of the vehicle 20 during rush hour based on the traffic congestion information on the predetermined road and the location information of the vehicle 20, specifically, the driving time included in the position information, and calculate a higher degree of stability for the vehicle having less driving total time. In this case, the information acquisition unit 111 as a congestion information acquisition unit acquires congestion information indicating the rush hour on the predetermined road from an external information distribution server (not illustrated) that distributes traffic information of the road via the communication control unit 114. In addition, the information acquisition unit 111 as a driving information acquisition unit acquires driving time information included in position information of each of the plurality of vehicles 20. The driving information acquisition unit may acquire information indicating the acquisition time of the driving information of each of the plurality of vehicles 20 as the driving time information. The evaluation unit 112 calculates the driving total time of each of the plurality of vehicles 20 during rush hour based on the congestion information and the driving time information, and calculates a higher degree of stability for the vehicle 20 having less driving total time. The road surface roughness can be more accurately evaluated by determining the vehicle to be evaluated based on the degree of stability calculated in this manner. The calculation may be based on the length of the section where the driving speed of the vehicle 20 was equal to or lower than a certain speed instead of the driving total time during the rush hour. More specifically, the degree of stability may be calculated higher for the vehicle 20 having a shorter length of the section where the driving speed of the vehicle 20 was equal to or lower than the certain speed. In this case, the evaluation unit 112 calculates the length of the section in which the driving speed of each of the plurality of vehicles 20 is equal to or less than the certain speed on the predetermined road based on the driving speeds of the plurality of vehicles 20 calculated from the temporal transition of the position information of the plurality of vehicles 20 or the measured driving speed and position information of the plurality of vehicles 20.

In the above embodiment, the evaluation unit 112 as a calculation unit calculates the degree of stability based on the driving information of the vehicle 20, and determines the vehicle 20 having the degree of stability equal to or greater than a predetermined degree as the vehicle to be evaluated. However, when there is a certain number or more of the vehicles 20 whose degree of stability is equal to or greater than a predetermined degree, the vehicle having higher degree of stability may be determined as the vehicle to be evaluated in priority so that the number of vehicles to be evaluated does not exceed the certain number.

In the above embodiment, the evaluation unit 112 as a generation unit generates the sudden operation information indicating the presence or absence of the sudden operation of the vehicle 20 based on the acceleration information included in the driving information of the vehicle 20. However, the generation unit may generate the sudden operation information based on the driving speed information or the steering angle information included in the driving information of the vehicle 20 in addition to or instead of the acceleration information.

In the above embodiment, in the processing of FIGS. 8 and 9, a command to request the vehicle 20 to transmit the driving information (hereinafter referred to as a transmission request command) is transmitted (S11 and S21). However, along with the transmission request command, a command to request the vehicle 20 to drive on the road to be evaluated (hereinafter referred to as a driving request command) may be transmitted. The driving request command includes information that can identify the road to be evaluated, and the vehicle 20 (in-vehicle terminal 30) that has received the driving request command outputs information (display information or voice information) to a display (not illustrated) or a speaker (not illustrated) provided in the cabin to encourage the occupant of the vehicle 20 to drive on the road to be evaluated based on the information. In addition, an incentive (reward) may be given to an occupant of the vehicle 20 that drove on the road to be evaluated in response to a driving request command. The incentive is, for example, a coupon that can be allocated to a part of the price in a case where the user purchases a product or receives a service at a store or the like. In addition, for the vehicle 20 that drove on the road to be evaluated in response to a driving request command, a higher incentive may be given to the vehicle 20 having a higher degree of stability of driving behavior. Further, the driving request command may include information requesting an occupant of the vehicle 20 to upload construction information. For example, information indicating a road construction section may be uploaded to the road surface evaluation apparatus 10 by an occupant of the vehicle 20 who recognizes the road construction section while the vehicle 20 is driving on the road to be evaluated and performs a predetermined operation on an operation unit (not illustrated) provided in the cabin. In this case, when detecting the predetermined operation, the in-vehicle terminal 30 (processing unit 310) transmits information indicating that the current driving position of the vehicle 20 is within the road construction section to the road surface evaluation apparatus 10 as a part of the driving information. An incentive may be further given to the occupant who uploads the construction information.

In the above embodiment, the information acquisition unit 111 as a driving information acquisition unit receives the driving information transmitted from the in-vehicle terminal 30 of the vehicle 20, and the received driving information is stored in the memory unit 120. However, the driving information transmitted from the in-vehicle terminal 30 of the vehicle 20 may be stored in an external storage device. For example, the driving information transmitted from the in-vehicle terminal 30 of the vehicle 20 may be transmitted to an external server (not illustrated) having a storage function and stored in a storage device (not illustrated) included in the external server. As described above, the external server may function as the driving information acquisition unit, and the evaluation unit 112 may read the driving information of the plurality of vehicles 20 acquired by the external server as the driving information acquisition unit within a predetermined period from the storage device and use it for the evaluation of the road surface roughness.

In the above embodiment, the output unit 113 outputs the road surface profile information to the user's terminal, but the output unit may output the road surface profile information to the memory unit 120 so that the road surface profile information is mapped to the map information stored in the memory unit 120. That is, any configuration of the output unit is acceptable as long as it outputs road surface profile information.

In the above embodiment, the information acquisition unit 111 as a map information acquisition unit acquires map information including information on the road on which the vehicle 20 is driving from the memory unit 120. However, the map information acquisition unit may acquire map information including information on the road on which the vehicle 20 is driving from an external server device or the like.

In the above embodiment, the road surface roughness values are expressed in terms of IRI, but the road surface roughness values may be expressed in terms of other indices. When the road surface roughness value obtained as training data is expressed by an index other than IRI, the evaluation unit 112 may calculate the road surface roughness value expressed by that index.

The above embodiment can be combined as desired with one or more of the above modifications. The modifications can also be combined with one another. The present invention allows efficient and accurate evaluation of road surface profiles.

Above, while the present invention has been described with reference to the preferred embodiments thereof, it will be understood, by those skilled in the art, that various changes and modifications may be made thereto without departing from the scope of the appended claims.

What is claimed is:

1. A road surface evaluation apparatus comprising
a microprocessor and a memory connected to the microprocessor, wherein
the microprocessor is configured to perform:
acquiring as driving information of a plurality of vehicles, position information of the plurality of vehicles, acceleration information indicating acceleration of the plurality of vehicles and map information including information of a predetermined road;
calculating a degree of stability of a driving behavior of each of the plurality of vehicles based on the driving information when the plurality of vehicles drove on the predetermined road in a past;
selecting a group of vehicles to be evaluated from among vehicles whose degree of stability is equal to or greater than a predetermined degree;
evaluating a roughness of a road surface of the predetermined road based on the driving information of the group of vehicles; and
outputting information on the roughness of the road surface evaluated in the evaluating in association with the information of the predetermined road.

2. The road surface evaluation apparatus according to claim 1, wherein
the microprocessor is configured to perform
the acquiring including acquiring, as the driving information, measured values of driving speeds of the plurality of vehicles transmitted from the plurality of vehicles, and
the calculating including calculating, based on the driving speeds of the plurality of vehicles calculated based on a temporal transition of a driving position of each of the plurality of vehicles indicated by the position information, or the measured values of driving speeds of the plurality of vehicles, the degree of stability for a vehicle with a smaller change in the driving speed among the plurality of vehicles as higher.

3. The road surface evaluation apparatus according to claim 1, wherein
the microprocessor is configured to perform
the acquiring including acquiring, as the driving information, measured values of steering angles of the plurality of vehicles transmitted from the plurality of vehicles, and further acquiring, as the driving information, lane change information indicating whether or not each of the plurality of vehicles has performed a lane change based on a temporal transition of a driving position of each of the plurality of vehicles indicated by the position information, or the measured values of steering angles of the plurality of vehicles, and
the calculating including calculating the degree of stability for a vehicle with a lesser number of lane changes among the plurality of vehicles as higher, based on the lane change information.

4. The road surface evaluation apparatus according to claim 1, wherein
the microprocessor is configured to further perform
generating sudden operation information indicating presence or absence of a sudden operation of each of the plurality of vehicles based on the acceleration information of each of the plurality of vehicles included in the driving information,
the microprocessor is configured to perform
the calculating including calculating the degree of stability for a vehicle with a lesser number of sudden operations among the plurality of vehicles as higher, based on the sudden operation information, and
the sudden operation includes any one of a sudden acceleration, a sudden deceleration, and a sudden steering.

5. The road surface evaluation apparatus according to claim 1, wherein
the microprocessor is configured to further perform
acquiring congestion information indicating a rush hour on the predetermined road,
the position information of each of the plurality of vehicles includes a driving position of each of the plurality of vehicles and a driving time at the driving position of each of the plurality of vehicles, and
the microprocessor is configured to perform
the acquiring including acquiring, as a driving time information, the driving time included in the position information of each of the plurality of vehicles or an acquisition time of the driving information of each of the plurality of vehicles, and
the calculating including calculating a driving total time of each of the plurality of vehicles during the rush hour based on the congestion information and the driving time information, and calculating the degree of stability for a vehicle with a lesser driving total time during the rush hour among the plurality of vehicles as higher.

6. The road surface evaluation apparatus according to claim 1, wherein
the microprocessor is configured to perform
the acquiring including acquiring, as the driving information, measured values of driving speeds of the plurality of vehicles transmitted from the plurality of vehicles, and
the calculating including calculating, based on the driving speeds of the plurality of vehicles calculated based on a temporal transition of a driving position of each of the plurality of vehicles indicated by the position information, or the measured values of driving speeds and the position information of the plurality of vehicles, a length of a section in which the driving speed of each of the plurality of vehicles is equal to or less than a certain speed on the predetermined road, and calculating the degree of stability for a vehicle with a shorter length of the section among the plurality of vehicles as higher.
